(19) United States
(12) Patent Application Publication
(10) Pub. No.: US 2001/0053677 A1
(43) Pub. Date: Dec. 20, 2001

(54) METHOD AND APPARATUS FOR INTEGRATING AN INTENTIONAL RADIATOR IN A SYSTEM

(76) Inventor: JEFFREY L. SCHIFFER, PALO ALTO, CA (US)

Correspondence Address: CYNTHIA THOMAS FAATZ, BLAKELY SOKOLOFF TAYLOR & ZAFMAN, 12400 WILSHIRE BLVD, 7TH FLOOR, LOS ANGELES, CA, 90025

(21) Appl. No.: 09/235,062

(22) Filed: Jan. 20, 1999

(51) Int. Cl. H04B 1/38

(52) U.S. Cl. 455/128; 343/846; 343/847; 343/848; 343/849; 455/90; 455/575; 455/318; 455/325; 343/841; 343/702; 361/816; 361/818; 361/736; 343/789; 343/853

(57) ABSTRACT

An intentional radiator includes an antenna and a ground plane. The ground plane is to be coupled to shielding that includes an opening for the antenna wherein the intentional radiator is to be positioned such that the antenna radiates through the opening. The shielding and the ground plane together act to reduce emissions through the opening.

### FIELD OF THE INVENTION

The present invention relates generally to an intentional radiator, and more particularly, to integration of an intentional radiator in a system.

### BACKGROUND OF THE INVENTION

In order to limit unwanted device emissions to meet Federal Communications Commission (FCC) standards, manufacturers of computer systems, and other types of devices that produce unwanted emissions, use some type of shielding. For a mobile computer system, for example, a metalized layer may be used inside a plastic housing to provide shielding. Metal-impregnated plastic, metallic paint, and/or a metal housing provide other examples of types of shielding for various applications.

Whatever shielding approach is used, the integrity of the shielding is a factor in determining whether the system or device that uses the shielding meets FCC standards for limiting unwanted emissions (set forth in 47 C.F.R. § 15).

An issue may therefore arise where a system, for example, uses shielding to reduce unwanted emissions, but it is desirable to integrate a radio frequency (RF) module, or other intentional radiator, within such a system. If the intentional radiator is enclosed within the shielding, the shielding will interfere with the operation of the intentional radiator.

Alternatively, an opening provided in the shielding to enable the intentional radiator to operate can allow unwanted device emissions radiated through the opening to rise to an unacceptable level.

One approach to addressing this issue is to provide an antenna for the intentional radiator on a computer card, such as a Personal Computer Memory Card International Association (PCMCIA) card. The antenna then extends outside a computer system beyond the shielding. For another approach, a unique type of connector is connected to a cable that connects to an external antenna. For some such approaches, the cable may need to be long.

Each of the above approaches, while providing for an antenna outside system shielding, has a drawback. The above approaches are not easily applied to, for example, an integrated intentional radiator module. An integrated intentional radiator module, as the term is used herein, refers to a module that may be certified as an intentional radiator in and of itself. Such a module may include an integrated antenna, or one that is coupled to the module by a fixed length of cable. Such a module may also include components that radiate unwanted emissions, and thus, should be shielded.

### SUMMARY OF THE INVENTION

A method and apparatus for integrating an intentional radiator in a system are described.

For one embodiment, an apparatus comprises an intentional radiator including an antenna and a ground plane, wherein the ground plane is to be coupled to shielding that includes an opening for the antenna. The intentional radiator is to be positioned such that the antenna radiates through the opening, while the shielding and the ground plane reduce emissions through the opening.

Other features and advantages of various embodiments will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 shows a cross-section of a system according to one embodiment that includes an integrated intentional radiator and one or more shielding connections.

FIG. 2 shows a cross-section of a system that includes an integrated intentional radiator of another embodiment wherein a ground plane is coupled directly to system shielding.

FIG. 3 shows a cross-section of a system that includes an integrated intentional radiator of yet another embodiment wherein a ground plane is coupled to system shielding by vias in a first P.C. board layer.

FIG. 4 is a top view of the intentional radiator of FIG. 3.

FIG. 5 shows a cross-section of an integrated intentional radiator of another embodiment wherein a ground plane is coupled to system shielding by vias in a different P.C. board layer.

FIG. 6 is a top view of the intentional radiator of FIG. 5.

FIG. 7 is a flow diagram showing the method of one embodiment for integrating an intentional radiator module in a system.

### DETAILED DESCRIPTION

A method and apparatus for integrating an intentional radiator in a system is described. Although the following embodiments are described with reference to a notebook computer system including an integrated radio frequency (RF) module, alternative embodiments are applicable to other types of systems that may benefit from the integration of an integrated RF module or another type of intentional radiator. Examples of such systems include, but are not limited to, cellular telephones, digital cameras and other types of mobile devices, such as laptops or personal digital assistants (PDAs).

For one embodiment, an intentional radiator includes an antenna and a ground plane wherein the ground plane is coupled to shielding that includes an opening for the antenna. The intentional radiator is positioned such that the antenna radiates through the opening while the ground plane and shielding together reduce the level of emissions through the opening.

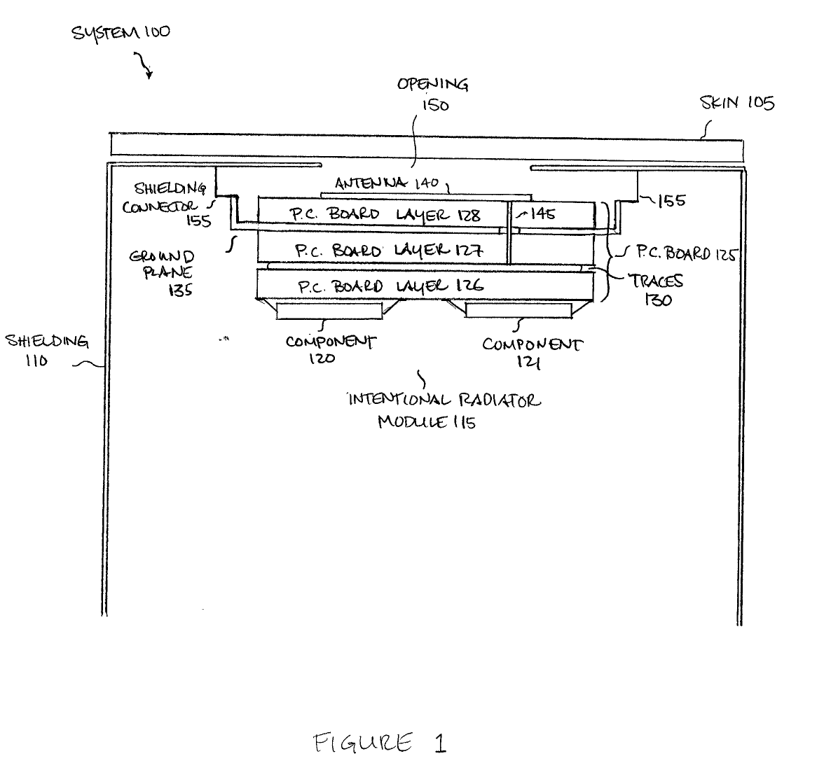

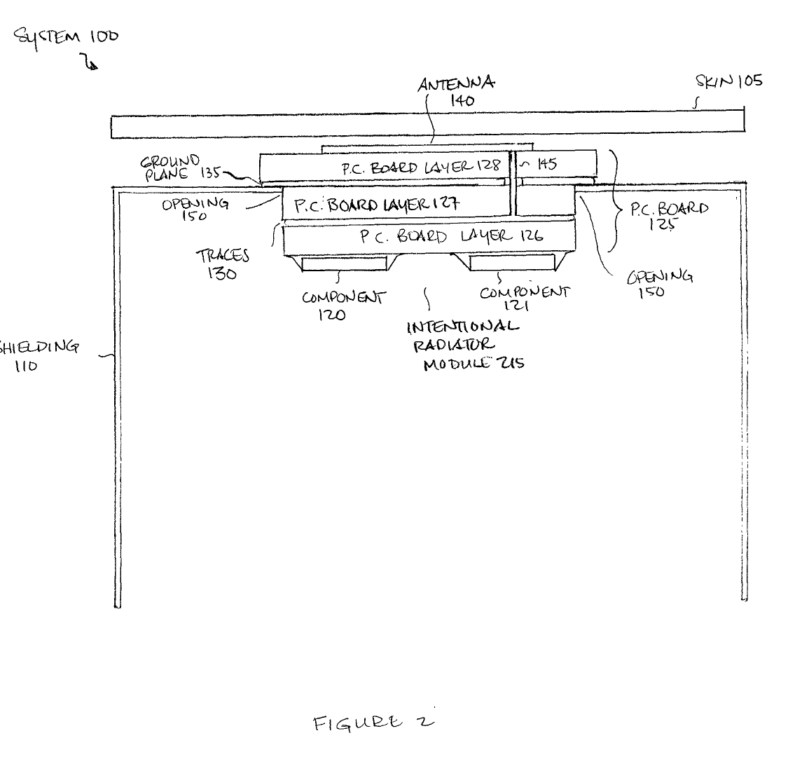

FIG. 1 is a cross-sectional view of a portion of a system 100. The system 100 is a notebook system in this example. The system 100 includes a skin 105 or other type of housing, shielding 110, and an integrated radio frequency (RF) module or other type of intentional radiator 115.

The notebook skin 105 may be formed of a plastic, for example, but other types of material are within the scope of various embodiments. In FIG. 1, the notebook skin 105 is only shown as extending across one side of the system 100. For other embodiments, the skin 105 may extend around multiple surfaces of the system 100 or may not be included.

The shielding 110 is provided to shield devices within the system 100 that produce unwanted emissions. For one embodiment, the shielding 110 comprises metallic paint or another type of metallic coating that is applied to an inner surface of the notebook skin 105. For another embodiment, the shielding 110 is formed of a metallic material that is fitted within the notebook skin 105. For yet another embodiment, the notebook skin 105 is formed of a metal or a metal-impregnated material such that the shielding is integral to the notebook skin 105 itself. Other types of shielding are also within the scope of various embodiments.

The intentional radiator module 115 of one embodiment is an integrated RF module that can be certified as a radiator on its own, outside of the system 100. The integrated intentional radiator module 115 includes components 120 and 121 connected to one side of a multi-layer printed circuit (P.C.) board 125. For one embodiment, one or both of the components 120 and/or 121 may produce unwanted emissions such that it is desirable to limit the level of such emissions that can be measured outside the notebook skin 105, for example.

The intentional radiator module 115 may include other devices not shown in FIG. 1 and/or may not include the components 120 and/or 121. Further, the system 100 may include other devices to be shielded that are not shown in FIG. 1. Such other devices are provided within the shielding 110.

For the example shown in FIG. 1, the multi-layer P.C. board 125 includes three layers 126-128, however, a different number of layers may be used for other embodiments. In FIG. 1, traces 130 are provided between the first and second layers 126 and 127, respectively, of the P.C. board 125 to interconnect the devices 120 and 121 and/or other devices (not shown). The traces may be formed of copper or another conductive material. Vias (not shown) may be provided to couple the traces 130 and/or the ground plane 135 to the components 120 and/or 121.

A ground plane 135 is provided between the second and third layers of the P.C. board, 127 and 128, respectively. The ground plane 135 may also be formed of copper or another conductive material and provides a ground for the components 120 and 121 and/or other components on the R.F. module 115.

An antenna 140 is provided on a side of the P.C. board 125 opposite from the components 120 and 121, and may be patterned or soldered onto the P.C. board 125. The antenna 140 radiates and receives signals from and to the intentional radiator module 115. The ground plane 135 also provides a ground for the antenna 140. Because of the fixed spatial relationship between the antenna 140 and the ground plane 135 for the embodiment shown in FIG. 1, the characteristics of the antenna 140 are well defined regardless of whether or not the module 115 is integrated in the system 100.

For another embodiment, the antenna 140 is a discrete antenna that is coupled to the P.C. board 125 by a short, fixed length cable (not shown). The antenna is coupled to other parts of the module 115 by one or more vias 145 through one or more of the P.C. board layers 126-128.

The shielding 110 includes an opening 150. For one embodiment, the opening 150 in the shielding 110 is larger in size and shape than the antenna 150, but not excessively large. Where the shielding is a metallic paint or coating, the opening 150 may be patterned in the shielding, for example. Where the shielding is another type of metallic layer, the opening 150 may be cut or punched from the shielding, or formed in another manner.

As discussed in the Background section, an opening in the shielding may allow undesirable levels of unwanted emissions to be measured outside of the system 100. For one embodiment, to reduce the level of unwanted emissions that radiate through the opening 150, one or more shielding connection(s) 155 is provided. The shielding connection(s) couple the shielding 110 to the ground plane 135 of the integrated RF module 115.

For one embodiment, the shielding connection(s) 155 extend around the entire opening 150 such that the ground plane, shielding connection(s) 155 and the shielding 110 form a continuous shield against unwanted emissions from components 120,121 and/or other devices in the system 100 (not shown).

For another embodiment, the shielding connection(s) 155 is coupled to one or more sides of the ground plane 135 to reduce the level of emissions that are radiated through the opening 150, but does not necessarily extend around the entire perimeter of the ground plane 135. While there may still effectively be an opening in the shielding for some embodiments, the level of emissions radiated through the opening 150 is lower than it would be where a ground plane is not positioned below the opening and/or a shielding connection is not used.

The shielding connection(s) 155 of one embodiment are formed of a flexible copper tape that is soldered to the ground plane 135 and the shielding 110. The flexible copper tape may extend around the entire perimeter of the ground plane such that the opening 150 is effectively sealed from a shielding point of view. For another embodiment, one or more strips of flexible copper tape may be soldered or connected to the shielding 110 and the ground plane 135 in another manner at one or more locations around the perimeter of the ground plane 135.

The shielding connection(s) of another embodiment comprise one or more metal bars or another type of metallic member that is mechanically coupled to the shielding 110 and the ground plane 135 by screws or another fastening member. Similar to the copper tape, the metal members(s) may be placed around the entire perimeter of the ground plane 135. Alternatively, one or more of the metal members may be placed at one or more locations around the perimeter.

The number and placement of shielding connection(s) and/or their spacing around the perimeter of the ground plane 135 may depend on several factors including, for example, the particular FCC requirements for unwanted emissions levels for the system 100 and the materials used to provide the shielding connection(s).

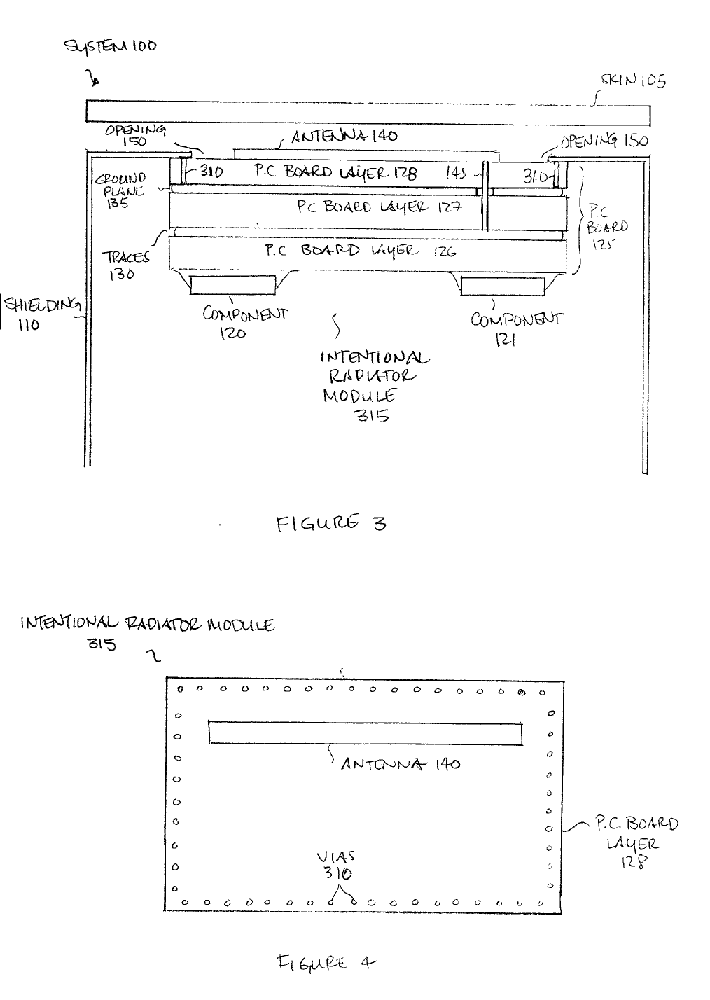

For yet another embodiment, the ground plane 135 may be formed such that discrete shielding connection(s) may not need to be provided. An example of such an embodiment is shown in FIG. 2.

As shown in FIG. 2, the P.C. board layer 128 of the intentional radiator module 215 extends beyond the perimeter of the P.C. board layers 126 and 127 on one or more sides. The ground plane 135 is provided on the side of the P.C. board layer 128 that interfaces with the P.C. board layer 127. In this manner, the ground plane 135 can be directly coupled to the shielding 110 on one or more sides of the intentional radiator module 215 to close, or partially close the opening 150 to unwanted emissions. This direct coupling may be accomplished through soldering or another approach.

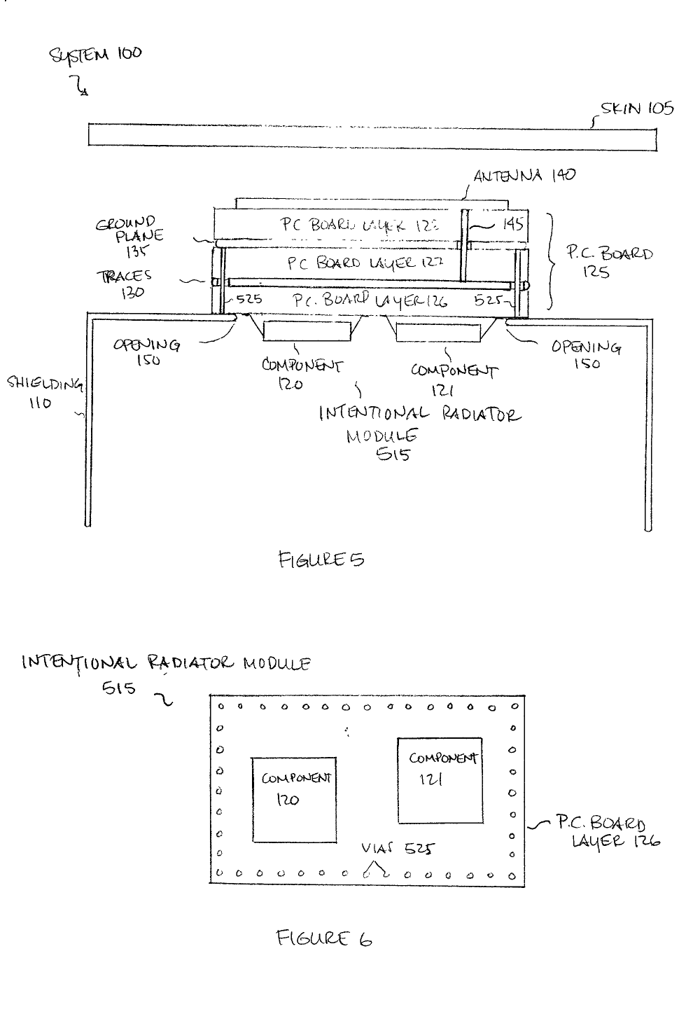

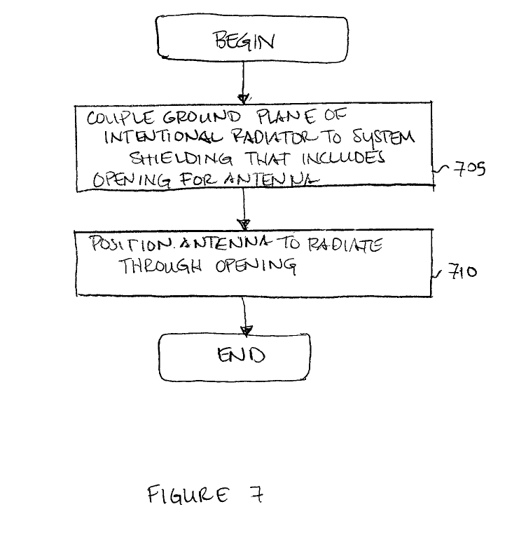

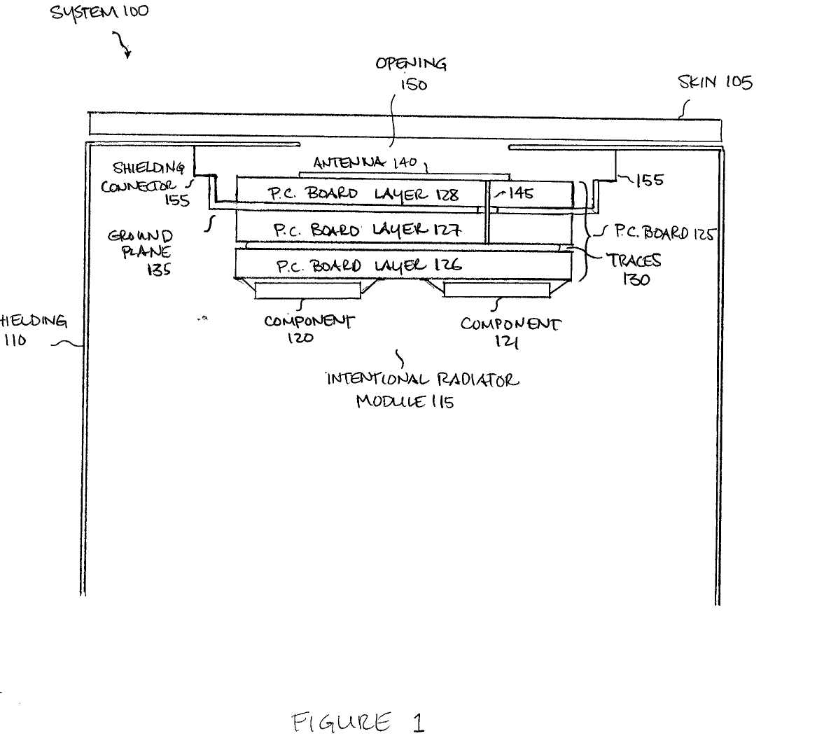

For another embodiment, as shown in FIGS. 3 and 4, one or more additional vias 310 may be provided between the ground plane 135 and a surface of an intentional radiator module 315. The intentional radiator module 315 may then be coupled to the shielding with screws or other mechanical connectors, or the intentional radiator module 315 may be soldered to the shielding 110 or connected in another manner. In this manner, the ground plane 135 is coupled to the shielding 110 to reduce unwanted emissions through the opening 150.

FIG. 4 is an overhead view of the intentional radiator module 315. While FIG. 4 shows vias 310 in a particular pattern around the perimeter of the P.C. board layer 128, any number of vias 310 may be provided in a different arrangement on the intentional radiator module 315. For example, the vias 310 may be placed immediately around the antenna 140. Further, while a particular shape is shown for the antenna 140, the antenna may be a different shape for other embodiments.

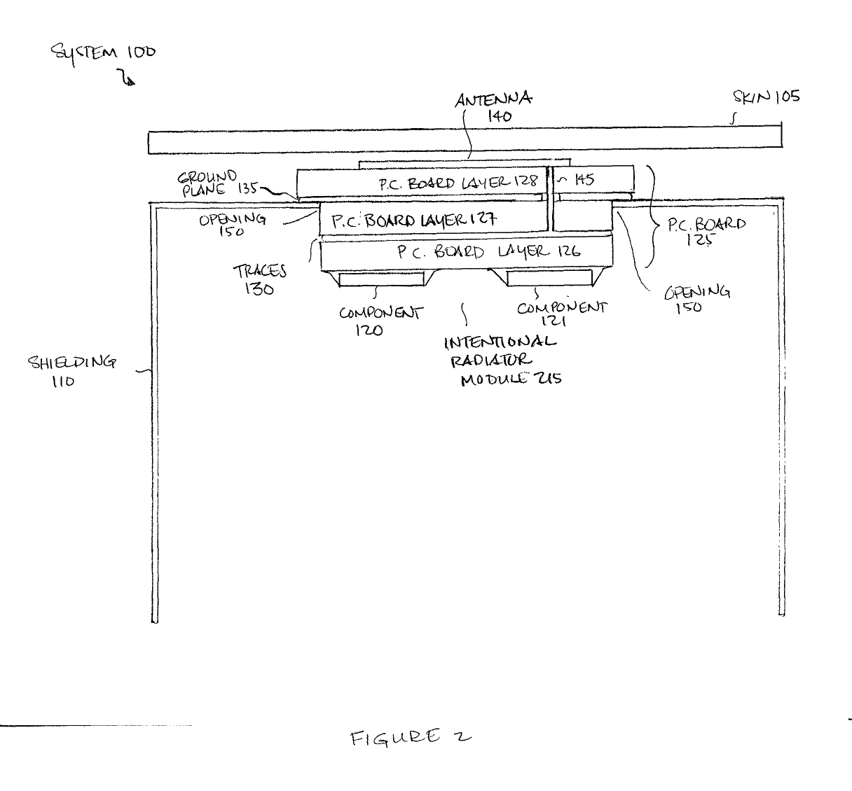

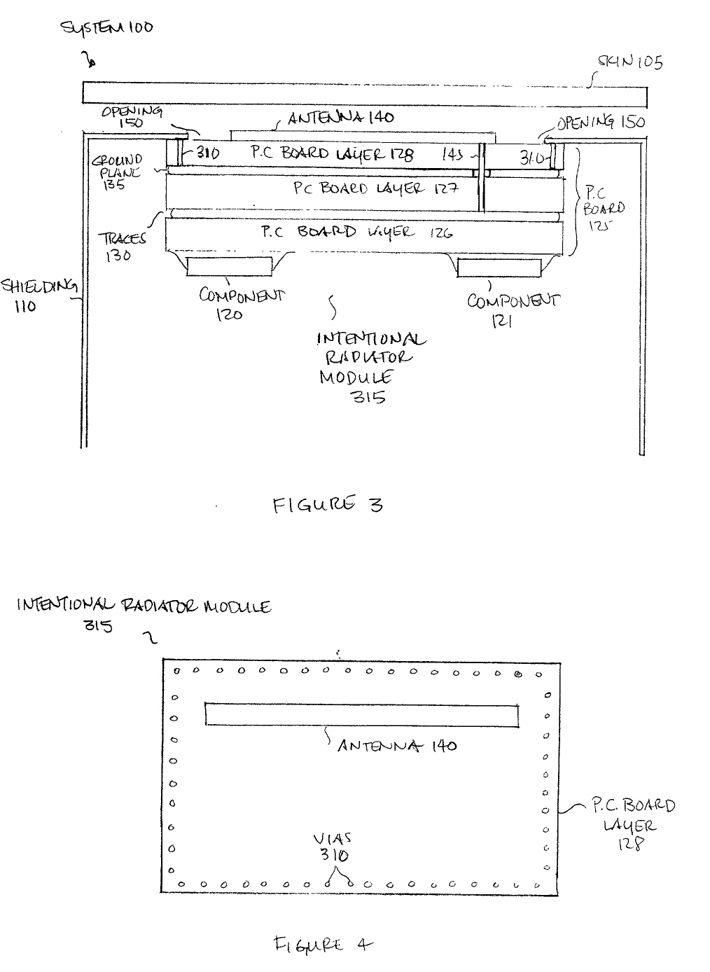

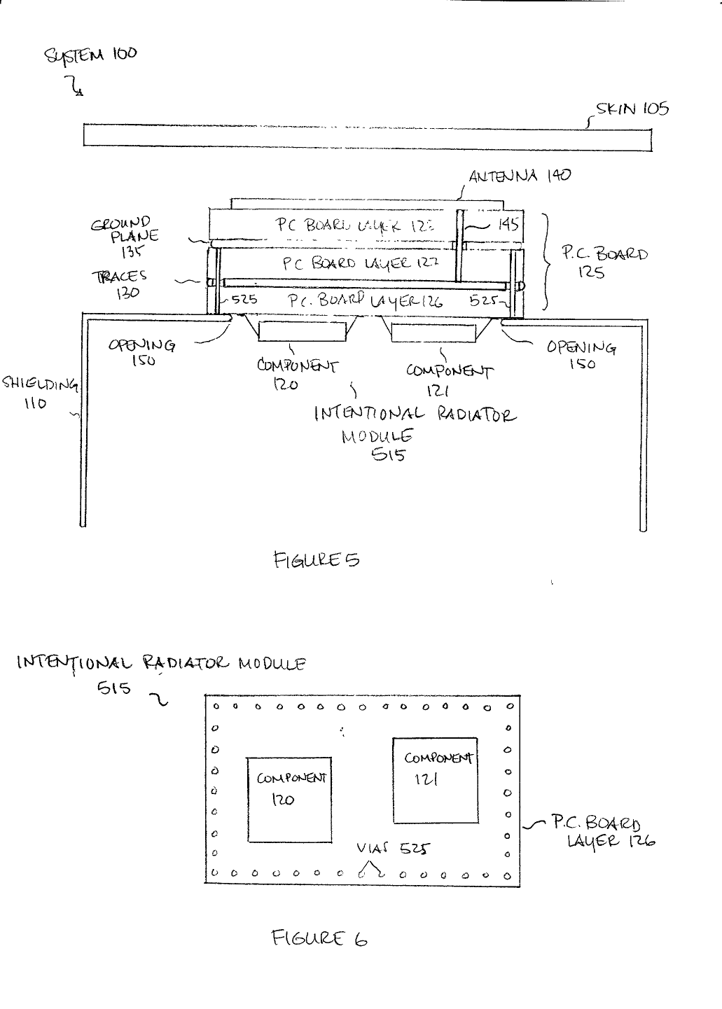

FIGS. 5 and 6 show an intentional radiator module 515 of another embodiment that is coupled to the shielding 110 in a similar manner to the embodiments shown in FIGS. 3 and 4. For the embodiments shown in FIGS. 5 and 6, however, one or more additional vias 525 extend through the P.C. board layers 127 and 126 to provide connections to the ground plane 135 on a surface of the P.C. board layer 126. In this manner, the intentional radiator module 515 may be directly coupled to the shielding 110 in the manner shown to reduce emissions through the opening 150.

FIG. 6 is an overhead view of the P.C. board layer 126 with one possible pattern for the vias 525. It will be appreciated that the vias 525 may be provided in any pattern to couple the ground plane 135 to the shielding 110.

While various examples of shielding connections and approaches to coupling the shielding and radiator ground plane have been described above, it will be appreciated that other types of shielding connection(s) 155 and/or other connection approaches may be used in accordance with various embodiments. Further, while specific details of an integrated RF module have been described, other types of intentional radiators that do not include a P.C. board, or that include a P.C. board configured in another manner, for example, are also within the scope of various embodiments.

In accordance with the above-described embodiments, an integrated intentional radiator module can be integrated into a system while still providing effective shielding to maintain unwanted emissions at an acceptable level. Further, the ground plane of the intentional radiator module itself is used to provide part of this shielding where an opening in the conventional shielding is provided for an antenna. In this manner, the ground plane can be used to serve multiple purposes without adding significant additional materials or cost to the system.

Also, where shielding is provided separately from a system skin or housing, it is not necessary to provide a hole in the housing in order to enable the intentional radiator to radiate. By providing the antenna as part of an integrated module that includes a ground plane used to effectively close an opening in shielding through which an antenna radiates, a separate opening in the skin is not needed.

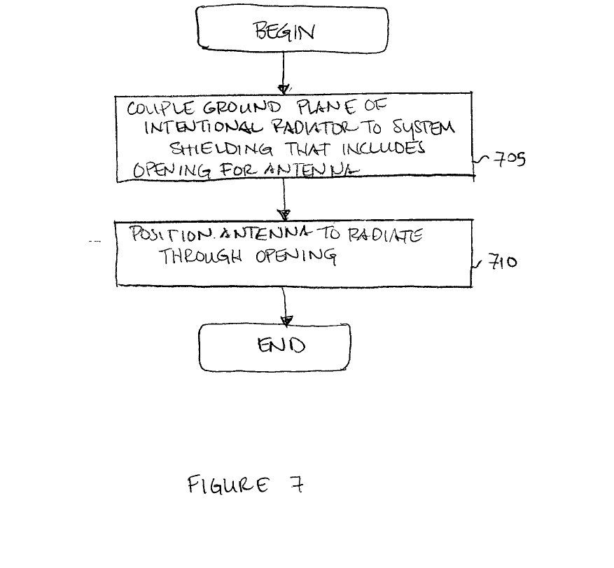

FIG. 7 is a flow diagram showing the method of one embodiment for integrating an intentional radiator into a system. At block 705, a ground plane of an intentional radiator module is coupled to shielding of the system in which the module is to be integrated. The system shielding includes an opening for an antenna on the intentional radiator module. For one embodiment, one or more connections are soldered between the ground plane and the shielding to couple the ground plane and the shielding. For another embodiment, the ground plane and shielding are mechanically coupled.

At block 710, the antenna is positioned proximate to the opening in the system shielding such that the antenna radiates through the opening. In the above manner, devices within an enclosure defined by the shielding and the ground plane are shielded to reduce unwanted emissions through the opening.

It will be appreciated that, for other embodiments, the method may not include all of the steps shown in FIG. 7 or may include steps not shown in FIG. 7.

In the foregoing specification, the invention has been described with reference to specific exemplary embodiments thereof. It will, however be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus comprising:
an intentional radiator including an antenna and a ground plane, the ground plane to be coupled to shielding that includes an opening for the antenna, the intentional radiator to be positioned such that the antenna radiates through the opening and the shielding and the ground plane reduce emissions through the opening.

2. The apparatus of claim 1 further comprising a shielding connection to couple the ground plane to the shielding.

3. The apparatus of claim 1 wherein the intentional radiator comprises a printed circuit board, the antenna being disposed on a first layer of the printed circuit board, the ground plane being disposed on a second layer of the printed circuit board.

4. An apparatus comprising:
an intentional radiator including an antenna and a ground plane; and
shielding including an opening, the antenna to radiate through the opening, the shielding being coupled to the ground plane, the ground plane to reduce emissions through the opening.

5. The apparatus of claim 4 wherein the intentional radiator comprises a multi-layer printed circuit board, the antenna being disposed on a first layer of the printed circuit board, the ground plane being disposed on a second layer of the integrated circuit board.

6. The apparatus of claim 4 further including a skin covering the opening.

7. The apparatus of claim 4 further including a shielding connection to couple the shielding to the ground plane.

8. The apparatus of claim 4 wherein the intentional radiator comprises a radio frequency module.

9. A system comprising:
a device to be shielded;
an intentional radiator including an antenna and a ground plane;
shielding enclosing the device to be shielded except for an opening proximate to the antenna, the shielding being coupled to the ground plane to reduce emissions through the opening by the device to be shielded.

10. The system of claim 9 further including a skin covering the opening.

11. The system of claim 9 wherein the device to be shielded is integrated with the intentional radiator.

12. The system of claim 9 wherein the intentional radiator includes a printed circuit board and wherein the antenna is included on a first layer of the printed circuit board and the ground plane is included on a second layer of the printed circuit board.

13. The system of claim 9 wherein the intentional radiator comprises a radio frequency module.

14. A method for integrating an intentional radiator in a system, the method comprising:
coupling a ground plane of an intentional radiator to system shielding that includes an opening for an antenna coupled to the intentional radiator.

15. The method of claim 14 further including positioning the antenna to radiate through the opening.

16. The method of claim 14 wherein coupling the ground plane to the system shielding includes soldering a connection between the ground plane and the system shielding.

17. The method of claim 14 wherein coupling the ground plane to the system shielding includes mechanically connecting the ground plane and the system shielding.

18. An apparatus comprising:
a means for shielding including an opening for an antenna; and
a means for coupling the shielding to a ground plane of an intentional radiator including the antenna, the ground plane and the means for coupling to reduce emissions through the opening.

19. The apparatus of claim 18 wherein the means for shielding comprises one of a metallic paint or a metal enclosure.

20. The apparatus of claim 18 wherein the means for coupling comprises one of mechanical connector or a soldered connection between the intentional radiator and the means for shielding.
